(19) United States
(12) Patent Application Publication
(10) Pub. No.: US 2018/0222620 A1
(43) Pub. Date: Aug. 9, 2018

(54) MULTI-TIERED ITEM PACKAGING CAROUSEL

(71) Applicant: Walmart Apollo, LLC, Bentonville, AR (US)

(72) Inventors: STEVEN LEWIS, Bentonville, AR (US); NICHOLAUS A. JONES, Fayetteville, AR (US); MATTHEW BIERMANN, Fayetteville, AR (US)

(21) Appl. No.: 15/880,799

(22) Filed: Jan. 26, 2018

Related U.S. Application Data
(60) Provisional application No. 62/455,170, filed on Feb. 6, 2017.

(51) Int. Cl. B65B 57/14; G06Q 20/20; B65B 5/06; B65B 35/30

(52) U.S. Cl. CPC B65B 57/14; B65B 35/30; B65B 5/067; G06Q 20/208

(57) ABSTRACT

An item packaging carousel is disclosed. The carousel includes a first tier and a second tier, each of the first tier and the second tier including a plurality of item receptacle compartments, each item receptacle compartment configured to hold at least one item receptacle; a motor configured to rotate at least one of the first tier or the second tier to bring one of the plurality of item receptacles to an active filling position; and an item packaging carousel control system including a processor and communications circuitry, the communications circuitry configured to receive item information from an item scanning system, and the item packaging carousel control system configured to provide a rotation signal to the motor to cause at least one of the first tier or the second tier to rotate to bring a selected one of the plurality of item receptacle compartments to an active filling position based on the received item information.

### RELATED APPLICATION

The present application claims the benefit of U.S. Provisional Application No. 62/455,170 filed Feb. 6, 2017, which is hereby incorporated herein in its entirety by reference.

### TECHNICAL FIELD

The present disclosure relates generally to purchased or ordered item management and more particularly to a multi-tiered item packaging carousel that automatically rotates to an available receptacle based on item information received from an item scanning system.

### BACKGROUND

Many retailers bag purchased items for customers as they check out. This can be a time-consuming process, as a store associate must locate and open a bag, and place it in a location for filling, before scanning items and placing them in the bag. As items are scanned and bagged, the associate must ensure each bag is properly filled (e.g., a minimum number of items are placed in the bag to justify use of the bag; a maximum number or weight of items in a single bag is not exceeded, which can risk bag rupture or a heavy bag not manageable by the customer; wet and dry items are not bagged together; some items, like raw chicken or beef products, are bagged separately because of the risk of package leakage and contamination) while also scanning items and getting and opening new bags as needed, which can take additional time. Similar challenges are faced by order fulfillment centers and other situations in which items are scanned and packaged for carrying, delivery or shipping.

### SUMMARY

Embodiments relate to systems and methods for a item packaging carousel and related methods. Specifically, some embodiments relate to a multi-tiered carousel with an auto-sensing motor to provide automated turning of carousel compartments.

In one embodiment, the carousel includes a first tier and a second tier, each of the first tier and the second tier comprising a plurality of item receptacle compartments, each item receptacle compartment configured to hold at least one item receptacle; a motor configured to rotate at least one of the first tier or the second tier to bring one of the plurality of item receptacles to an active filling position; and an item packaging carousel control system comprising a processor and communications circuitry, the communications circuitry configured to receive item information from an item scanning system, and the item packaging carousel control system configured to provide a rotation signal to the motor to cause at least one of the first tier or the second tier to rotate to bring a selected one of the plurality of item receptacle compartments to an active filling position based on the received item information.

In one embodiment, a method of managing an item packaging carousel includes providing an item packaging carousel, the item packaging carousel comprising a first tier and a second tier, each of the first tier and the second tier comprising a plurality of item receptacle compartments, each item receptacle compartment configured to hold at least one item receptacle, the item packaging carousel further comprising a motor configured to rotate at least one of the first tier or the second tier to bring one of the plurality of item receptacle compartments to an active filling position; and providing communications circuitry to communicatively couple the item packaging carousel with an item scanning system such that the motor causes at least one of the first tier or the second tier to rotate to bring a selected one of the plurality of item receptacle compartments to the active filling position based upon item information received from the item scanning system.

In one embodiment, a method of operating an item packaging carousel having a motor, a control system, and a rotating structure with a rotatable first tier and a rotatable second tier each having a plurality of item receptacle compartments, comprising receiving item information from an item scanning system related to an item scanned during a purchase transaction; communicating the item information to the control system of the item packaging carousel; monitoring compartment status information by the control system for each of the plurality of item receptacle compartments on the rotatable first tier and the rotatable second tier; determining a selected compartment of the plurality of item receptacle compartments in which to package the item based on the item information and compartment status information; rotating one of the rotatable first tier and the rotatable second tier with the motor to align the selected compartment with an active filling location; and updating compartment status information upon placement of the item in the selected compartment at the active filling location.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a diagram of a checkout configuration including an automated, multi-tiered item packaging carousel according to an embodiment.

FIG. 2 is an example perspective view of an automated, multi-tiered item packaging carousel according to an embodiment.

FIG. 3 is a block diagram of an automated, multi-tiered item packaging carousel system according to an embodiment.

FIG. 4 is a block diagram of a method of managing an automated, multi-tiered item packaging carousel according to an embodiment.

FIG. 5 is a block diagram of a method of operating an automated, multi-tiered item packaging carousel according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments relate to a multi-compartment packaging carousel that comprises an auto-sensing motor to start and stop rotation of the carousel as item receptacles, such as bags or boxes, are filled and new receptacles are needed. Embodiments also can comprise weight sensors to auto-detect when each receptacle has reached capacity and then initiate rotation of the carousel to make a new receptacle available to the associate. Similarly, embodiments also can comprise height capacity sensors to auto-detect a necessary receptacle type or size, or when each receptacle has reached a particular height capacity and then initiate rotation of the carousel to make a new receptacle available to the associate. Embodiments may also comprise sensors to ensure a minimum or maximum number of items is present in a receptacle to automatically regulate capacity before initiating rotation to make a new receptacle available to the associate.

In various embodiments, the carousel can communicate (wired and/or wirelessly) with an item scanning system, such as a retail POS system, order fulfillment system, or inventory management system, to identify items as they are scanned and manage the carousel based at least in part on this information. This may include grouping certain items in selected receptacles.

In one embodiment, the carousel further comprises an automated spectrometer to detect the type of item being packaged to alert the associate if a new receptacle is needed or items should be separated. The carousel can auto-rotate to another receptacle (e.g., a bag for wet items that has not yet reached capacity, or a plastic rather than paper bag) as additional items are scanned.

In yet another embodiment, the carousel can further comprise an automatic receptacle opener (e.g., for opening handled plastic bags) to automatically open new receptacles as the carousel automatically rotates as needed.

While examples used herein may relate to retail POS systems and carousels with bags to hold purchased items, embodiments also include order fulfillment and other item processing systems. These systems may use different types or sizes of item packaging or receptacles, such as one or more of boxes, mailers, envelopes or other packaging materials instead of or in addition to bags. Therefore, examples that refer to retail POS systems and bags are not limiting but used herein for illustration and discussion.

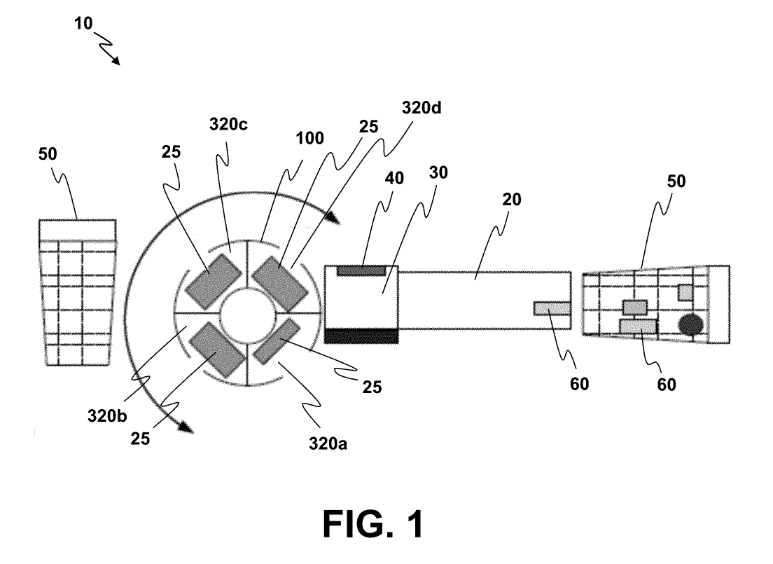

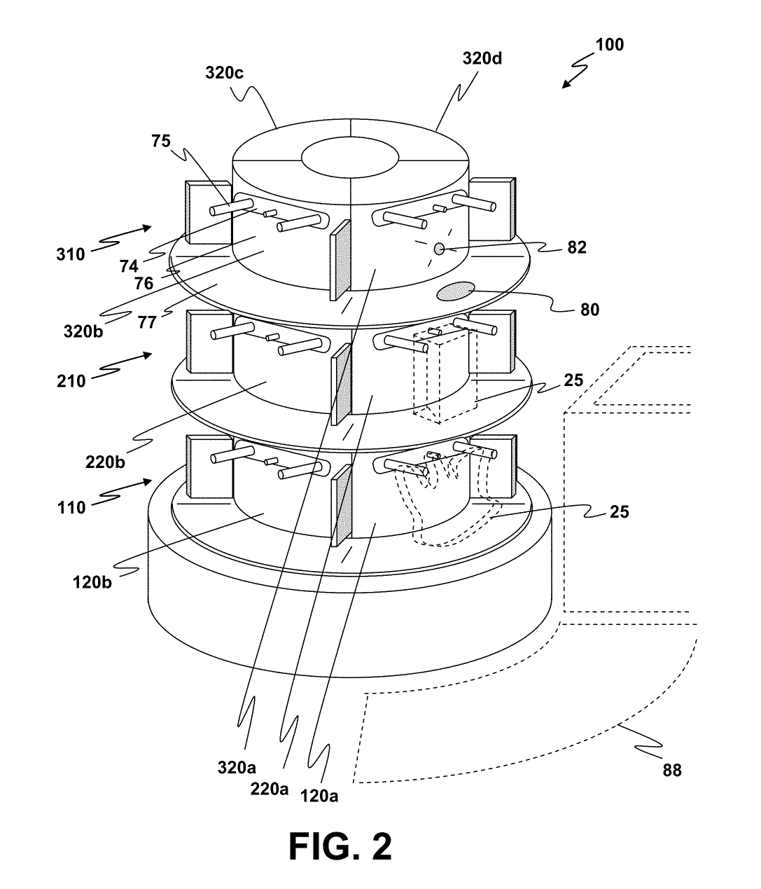

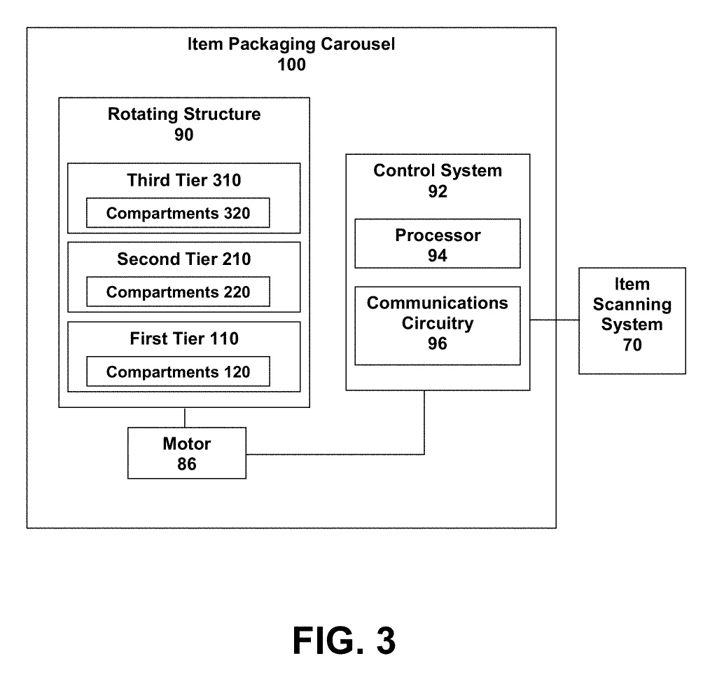

The components of various embodiments of a checkout or order fulfillment arrangement can be understood with reference to FIGS. 1-3 generally. FIG. 1 shows a shopping checkout system 10 according to one embodiment. Shopping checkout system 10 includes a checkout conveyor lane 20, a cashier station 30, a scanner 40, shopping carts 50, selected retail items 60 and a multi-tiered shopping bag carousel 100 equipped with bags 25. FIG. 2 shows a perspective view of an example of multi-tiered shopping bag carousel 100. FIG. 3 shows a diagram that includes an overview of shopping bag carousel 100 components and arrangement.

With reference to FIG. 1, upon completion of retail item selection in a store, a customer brings his or her shopping cart 50 (or, alternatively, a hand basket or loose items carried by hand) to a location adjacent the end of checkout conveyor lane 20. Items 60 are unloaded onto the checkout conveyor lane 20 and subsequently moved to the location of cashier station 30 by the conveyor system, which can be automated (i.e., comprises one or more sensors to automatically advance the conveyor belt as items are removed from the conveyor belt at cashier station 30). At cashier station 30, items 60 are scanned by a scanner 40 (or manually entered) and information related to each item 60 is recognized by a POS system 70 (see FIG. 3). Specifically, POS system 70 can recognize and look-up item information including price and description of the item. In other embodiments, POS system 70 can include or instead comprise an order fulfillment system, an inventory management system or some other system for tracking purchase, transfer or movement of items.

Item information generally relates to the item 60 scanned by, or manually entered into, POS system 70. The item information can include details such as the product weight, height, or other characteristics in certain embodiments. The item information may also contain classifications of the item based on particular categories. For example, in the context of groceries, categories such as “frozen food,” “produce,” or “raw meat” can be used. Retail items 60 can readily be grouped or classified according to any number of parameters that is deemed useful to the store and its sales or bagging operations. Grouping items 60 according to any desired characteristic or category should be deemed contemplated by this disclosure. Accordingly, item information can include an item type, item department, an item category, an item bag type, an item weight, an item dimension, an item destination, and/or an item state. Item bag type can represent a type of material in some embodiments, such as paper, plastic, or cloth. In some embodiments, item bag type can be replaced or supplemented with item receptacle type, such as box, mailer, envelope, bag, or some other type of receptacle for carrying, delivering, transporting or otherwise moving items.

Accordingly, data about scanned items 60 is looked up by the POS system from a product database and the scanned items 60 are recorded. The product database can comprise one or more databases. A database is a structured set of data held in a computer device, such as a server. Database software provides functionalities that allow building, modifying, accessing, and updating both databases and the underlying data. Databases and database software reside on database servers. Database servers are collections of hardware and software that provide storage and access to the database and enable execution of the database software. The database(s) accessed by POS system 70 can be local (e.g., located in the retail store) or remote (e.g., located at or facilitated by a home office of a retailer) and can be accessed wired and/or wireless by POS system 70.

Once identifying information about an item is obtained by POS system 70, the information is used to assist in the control of shopping bag carousel 100. In some embodiments, shopping bag carousel 100 is a multi-tiered structure of axially-aligned, independently-rotatable, tiers. In FIGS. 2 and 3, three tiers make up the carousel 100 and are generally referred to as tiers 110, 210, and 310. The embodiment of FIG. 2 is largely described herein for exemplary purposes, although many other configurations and embodiments should be understood to be contemplated as well. For example, similar structures having one, two, four, five or more tiers are possible. The perimeters of tiers 110, 210, and 310 in FIG. 2 are generally circular in shape, though tiers having flat perimeter segments or other shapes or geometries are contemplated as well. In some embodiments, the respective tiers will be three-sided or have a triangular perimeter shape. In some embodiments, the respective tiers will be square, four-sided, or have other multi-sided polygon cross-sectional perimeter shape. Tiers 110, 210, 310 can have the same shapes and configurations, or different shapes and configurations, in various embodiments.

Tiers 110, 210, and 310 in FIG. 2 have similar diameters; however, tiers of ascending or descending diameters are contemplated as well. In some embodiments, an upper tier or tiers having smaller diameter(s) enable greater ease of access for loading items 60 into the lower tier or tiers. The height of tiers 110, 210, and 310 from the ground may vary and are not limited in any way by the example of FIG. 2. Further, the respective heights of the individual tiers are not limited by the examples depicted or described herein. Tier heights may be the same or different from other tiers in the carousel 100 depending on the design. Tier heights and dimensions can be configured for differently sized and configured bags on different tiers or in different segments. For example, tier 310 can be configured to hold smaller plastic bags, tier 210 can be configured to hold medium plastic bags, and tier 110 can be configured to hold larger plastic bags and paper bags. In another example, tier 310 can be configured to hold smaller padded envelopes, tier 210 can be configured to hold medium plastic mailers, and tier 110 can be configured to hold larger cardboard or other boxes. In yet another example, receptacles types are not segregated by tier, such that, e.g., tier 210 can be configured to hold both plastic mailers and smaller boxes, or some other combination of receptacles.

Each tier 110, 210, and 310 is respectively divided into a plurality of compartments 120, 220, or 320. In the example of FIG. 2, each tier 110, 210, and 310 is divided into four compartments, but other embodiments can have more or fewer compartments in one or more of tiers 110, 210, and 310. The compartments of the first tier 110 are respectively compartments 120a, 120b, 120c and 120d (or generically “compartments 120”). Similarly, the compartments of the second tier 210 are respectively compartments 220a, 220b, 220c and 220d (or generically “compartments 220”). Similarly, the compartments of the third tier 310 are respectively compartments 320a, 320b, 320c, and 320d (or generically “compartments 320”). Compartments 220c, 220d, 120c, and 120d are not identified in FIG. 2, but can be understood to be generally at locations vertically disposed below compartments 320c and 320d.

Each compartment 120, 220, 320 is generally equipped with bags or other item receptacles for loading scanned items 60. Various known arrangements and components for supplying bags 25 are possible at each compartment. These can include bag readiness systems from which bags can be conveniently dispensed. Some bag readiness systems include a bag opening component. In FIG. 2, a generic bag holding structure 74, having arms 75 for supplying and holding open bags 25 for loading, is depicted in each compartment 120, 220, 320. Bag holding structure 74 is mounted on a wall 76 and extends over a base surface 77. Arms 75 are only generically shown in FIG. 2 and can include rods, racks, clips, or other structures comprising metal, plastic, wood or some other material for conveniently dispensing and/or opening bags 25. The generic bag holding structure 74, arms 75, wall 76 and base 77 should not be viewed as limiting and are intended to generically represent any type of bag dispensing, opening, or holding structure available. Such bag holding structures 74, for example, may hold more than one bag 25 open at a time in some embodiments, or may be equipped with any number of arm structures. The bag holding structure 74, wall 76, or base 77 may hold bags 25 or boxes of various types including plastic bags, paper bags, reusable bags, envelopes, mailers, cardboard boxes, recycled boxes, plastic bins, or containers or receptacles of other material or items. For purposes of this disclosure, bags 25 are intended to reference plastic bags, paper bags, or any other type of holding receptacle, container, or structure. In some embodiments, compartments 320 in the upper tier 310 can provide smaller bags 25 than the compartments 120 or 220 on the lower tiers. In some embodiments, compartments 320 in the upper tier 310 can provide different types of bags 25 than the compartments 120 or 220 on the lower tiers, as previously mentioned.

Each compartment 120, 220, 320 may be further equipped with various detection equipment and sensors 80. Sensors 80 can include weight sensors, infrared (IR) cameras, height sensors, optical sensors, temperature sensors, and spectrometers. Sensors 80 can be used to detect an item loaded into a bag 25. Sensors 80 can further be used to detect the weight or height of items 60 in a bag 25. For example, sensors 80 may determine that a bag 25 is full once a weight of over five pounds is detected, items have reached a height over twelve inches, or if ten items are loaded into a bag 25. Other weights, item sizes and/or item counts can be used in other embodiments and in some embodiments can be customized by the retailer according to their preferences or specifications. Sensors 80 may further ensure that a minimum number of items are placed in a bag 25 before the bag is deemed full as well. For example, if fewer than six items are in a bag, it will not be considered full in certain embodiments. The algorithms used by the carousel system to determine parameters for full or available bags can be adjusted and optimized to achieve the desired packing results.

Sensors 80 can be located in various desired locations of the compartments. These may include locations surrounding or along the edges of the holding structure 74, the adjacent wall 76, and/or the base 77. In some embodiments, different sensors are located on different tiers.

Sensor 80 shown in FIG. 2 is generically included for reference. The type and location of sensor 80 is not limited in any way by this reference.

Each compartment 120, 220, 320 may be further equipped with various lights 82. Lights 82 may include LEDs, directional lighting, colored lights, or any other lighting of various sizes and shapes. Lights 82 may be located in various desired locations of the compartments. These may include locations surrounding or along the edges of the holding structure 74, the adjacent wall 76, or the base 77. In some embodiments different lights 82 are located on different tiers. Light 82 shown in FIG. 2 is generically included for reference. The type and location of light 82 is not limited in any way by this reference.

Lights 82 can be used to highlight which tier or compartment to load and bag an item. In some embodiments, different colored lights can be used to provide visual directions to a bagger, such as which compartment to use (generally lit), which compartment is for wet or frozen items (lit blue), which compartment holds a full bag (lit red), etc. Such lighting can make it very convenient to identify appropriate compartments and bags 25 for packing items. Specifying which bag 25 to load items into can help ensure that only appropriate items are packed with one another. For example, detection of item information by the POS system 70 will only identify a separate compartment and bag for packaging items such as raw chicken that could pose a safety risk if contact and contamination of other items were to occur. Items that are wet can be permitted to only be packed with one another, so as not to negatively impact dry items. If desired, only refrigerated items would be packed together for customer convenience, among other reasons.

Carousel 100 can provide automatic, independent, bi-directional rotation to each of the tiers 110, 210, and 310. A start/stop motor 86 within the carousel 100 can drive rotational movement of the respective tiers and compartments. Some embodiments may rely on more than one motor 86. Accordingly, a bag 25 in a bagging compartment can be used, the tier rotated to advance another bag 25, then rotation of the tier reversed for revisiting and packing a previously-used but not full bag.

Bags 25 are typically loaded by an associate or individual at a bagging location 88 adjacent the cashier station 30. In some instances, the individual may be a consumer undertaking self-checkout. In others, location 88 may be in an order fulfillment or similar environment. Accordingly, carousel 100 can be designed to rotate the desired compartments for loading to be next to this bagging location 88. Compartments that are rotated to a position adjacent the associate or bagger are considered to be in the active bagging position. For example, in FIGS. 1 and 2, the bags 25 situated for loading from active bagging position are those in compartments 120a, 220a, and 320a. In some embodiments, the active bagging position is aligned with a conveyor system of the checkout lane 20, cashier station 30 or POS system 70 generally. In certain designs, more than one compartment on a tier may be adjacent the bagging location 88. The exact location of the bagging location 88 and the carousel 100 relative to the checkout lane 20 and cashier station 30 can vary. This location should not be limited to the locations of carousel 100 in FIG. 1 or 2, for example. In some embodiments, items in the “active bagging position” may also be intended to specifically refer to compartments located adjacent the bagger and that are also lighted with lights 82 or other indicators indicative of a particular bag 25 or compartment intended for loading. In some designs, the bags 25 in the respective compartments may be automatically opened using a bag readiness system, as previously mentioned. Automatic opening of a bag can be an indication to an individual that the newly opened bag is to be used for active bagging, in some embodiments.

FIG. 3 depicts a block diagram of a shopping bag carousel system. Specifically depicted is a shopping bag carousel 100 including a motor 86, a rotating structure 90, and a control system 92. Rotating structure 90 includes a first tier 110, second tier 210, and third tier 310. Any number of tiers could be present, however. As shown, tiers 110, 210, 310 include a plurality of compartments 120, 220, and 320, respectively. Control system 92 includes a processor 94 and communications circuitry 96. Also shown in FIG. 3 is a connection of the POS system 70 to the control system 92.

Once data is received and looked up regarding scanned or entered items 60 in the POS system 70, communications circuitry 96 of the control system 92 receives the item information for processing by processor 94. Control system 92 may receive the item information by wired or wireless connection to the POS system 70. Processor 92 accordingly provides a rotation signal to the motor 86 which causes the motor 86 to selectively rotate the tiers of the rotating structure 90. Based on the received item information, the rotation signal causes at least one of the tiers 110, 210, of 310 to rotate to bring a selected one of the bagging compartments 120, 220, or 320 to an active bagging position. In various embodiments, the motor 86 is configured to rotate the tiers 110, 210, 310 independently. Processor 94 can include a wide variety of computing devices, microprocessors, modules and other types of computing devices as detailed later in this disclosure. Similarly, the communications circuitry 96 can include any known wired, wireless, or other hardware components, or assembly for data transfer.

In some embodiments, processor 94 of control system 92 is configured to monitor a fill level of bags on the shopping bag carousel or compartment status information of the various compartments generally. Shopping bag carousel control system 92 is configured to provide a rotation signal to motor 86 to cause at least one of first tier 110 or second tier 210 or third tier 310 to rotate to bring a selected one of the plurality of bagging compartments 120, 220, 320 to an active bagging position based on the fill level or compartment status information.

In one example, a selected one of the plurality of bagging compartments 120, 220, 320 that is brought to the active bagging position based on the fill level is a bag 25 that is partially full and has not reached a maximum fill level. In another example, the selected one of the plurality of bagging compartments 120, 220, 320 that is brought to the active bagging position based on the fill level is an empty bag 25. In such a case, the fill level relates to a bag 25 previously in the active bagging position and that reached a maximum fill level.

In one embodiment, first tier 110 is configured to hold a first type of bag 25 and second tier 210 is configured to hold a second type of bag 25. The first type of bag 25 and the second type of bag 25 can be made of different bag materials and/or different bag sizes.

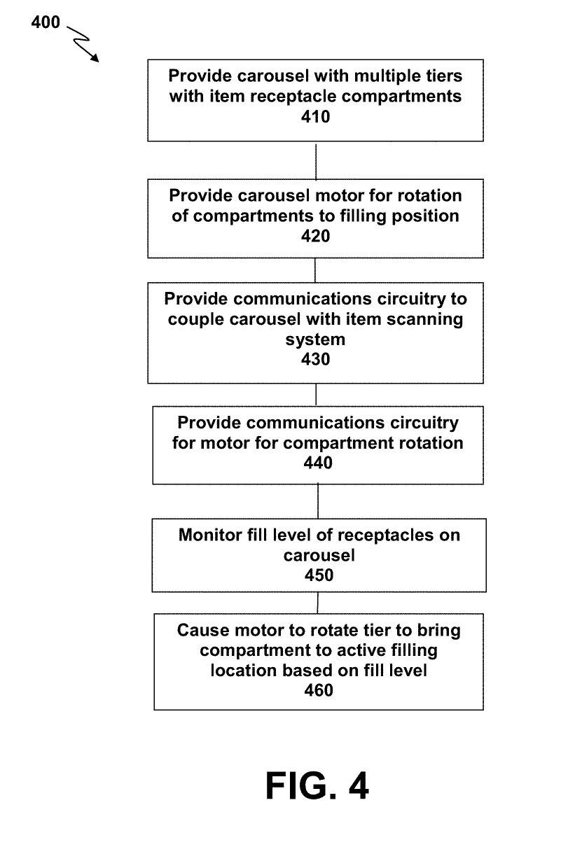

FIG. 4 discloses a block diagram of a method 400 of managing an item packaging carousel, such as a shopping bag carousel. The method 400 includes providing a carousel 100 and providing communications circuitry 96. At 410, a carousel 100 is provided with multiple tiers with bagging components. Carousel 100 can comprise a first tier 110 and a second tier 210. Each of first tier 110 and second tier 210 includes a plurality of bagging compartments 120 and 220, respectively. Each bagging compartment 120, 220 is configured to hold at least one bag 25.

At 420, carousel 100 is provided including a motor 86 for rotation of compartments 120, 220 to a bagging position. Specifically, carousel 100 further includes motor 86 configured to rotate at least one of first tier 110 or second tier 210 to bring one of the plurality of bagging compartments 120, 220 to an active bagging position. Referring to 430, communications circuitry 96 is provided to couple carousel 100 with POS system 70. Specifically, communications circuitry 96 is provided to communicatively couple carousel 100 with a retail POS system 70.

Further, at 440, communication circuitry is provided for motor 86 for rotation of a compartment 120 or 220. Specifically, communication circuitry 96 is provided to communicatively couple to POS system 70 such that motor 86 causes at least one of first tier 110 or second tier 210 to rotate to bring a selected one of the plurality of bagging compartments 120 or 220 to the active bagging position based on item information received from POS system 70. At 450, the fill level of bags on carousel 100 is monitored. This may include monitoring compartment status information in some embodiments.

At 460, motor 86 is caused to rotate one of the tiers to bring the bagging compartment to an active bagging location based on fill level. Specifically, motor 86 is caused to rotate at least one of first tier 110 or second tier 210 to bring a selected one of the plurality of bagging compartments 120 or 220 to an active bagging position based on the monitored fill level or, alternatively, based on compartment status information.

In some embodiments, the selected one of the plurality of bagging compartments 120 or 220 brought to the active bagging position is a bag 25 that is partially full and has not reached a maximum fill level or capacity. In some embodiments, the selected one of the plurality of bagging compartments 120 or 220 brought to the active bagging position is an empty bag 25. In such a case, the fill level can relate to a bag 25 previously in the active bagging position that reached a maximum fill level.

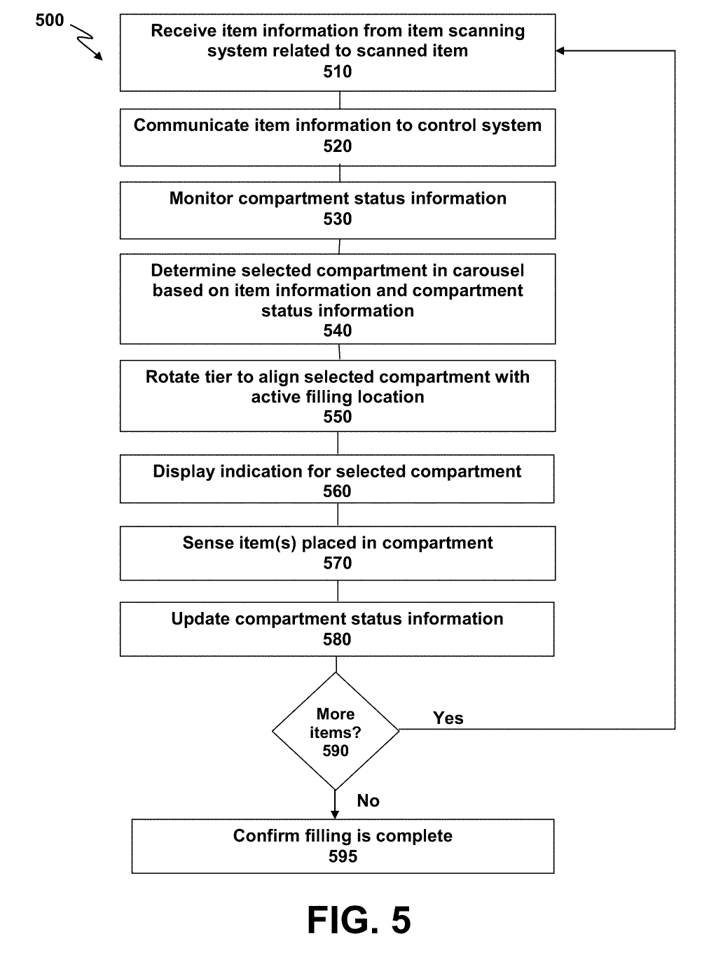

FIG. 5 shows a block diagram of a method 500 of operating a carousel 100. The method 500 generally relates to a shopping bag or other item receptacle carousel 100 having a motor 86, a control system 92, and a rotating structure 90 with a rotatable first tier 110 and a rotatable second tier 210 each having a plurality of bagging compartments 110 and 220.

At 510, the information from the POS system is received related to a scanned item 60. Specifically, this action relates to receiving item information from a POS system 70 related to the item 60 that is scanned by a scanner 40 during checkout.

Further, at 520, item information is communicated to control system 92, and at 530, compartment status information is monitored by control system 92 for each of the plurality of bagging compartments 120 and 220 on the rotatable first tier 110 and the rotatable second tier 210. Compartment status information relates to a fill level, product classification, or other limitation on bag availability.

Referring to 540, the method further includes determining a selected compartment of the plurality of bagging compartments 120, 220 to bag item 60 based on the item information and compartment status information that is being monitored.

At 550, the method also includes rotating one of the rotatable first tier 110 and the rotatable second tier 210 of carousel 100 with the motor 86 to align the selected compartment with an active bagging location.

Now in reference to 560, displaying an indication for the selected compartment is set forth. Displaying an indication may include lighting one or more lights 82 on the wall 76 or bag holding structure 74 of a particular compartment. This activity is not required in certain embodiments and need not be included in various methods as mere rotation of a tier or other identifying action may be sufficient for an individual to readily recognize the desired compartment for selectively bagging items 60.

At 570 as shown in FIG. 5, items placed in the bag 25 of the selected compartment are sensed using sensors 80 associated with that compartment, for example. Further, at 580, compartment status information is updated upon placement of item 60 in the selected compartment at the active bagging location.

At 590, a determination of whether more items 60 are present which require bagging. If another item 60 is present, the carousel starts the method again at 510 for that item 60. If no further items require bagging, confirmation that bagging is complete takes place at 595. This may be followed by customer payment and checkout completion in certain embodiments.

Still other variations and possibilities exist with respect to other embodiments. For example, in addition to lighting of bags or compartments other feedback can be provided to a user. In one embodiment, audible feedback can be used, such as to indicate that a bag is full or that the carousel is about to rotate. In another embodiment, additional visual feedback can be provided, such as text or a photo that identifies an item to be placed in a particular receptacle or compartment. This can be useful in some situations in which items are not scanned individually but rather presented for bagging or packaging as a group. In situations like these, the system can consider the items to be packaged as a group and then direct a user where and how to package particular items, and in what order or arrangement, using the carousel. In still other embodiments, the system can direct a user to use or include supplemental packaging materials, such as bubble wrap, paper, air packs, ice packs, cold or freezer bags, as items are added to receptacles in the carousel or once the system determines that a particular receptacle is full or otherwise ready for next steps in the packaging process.

In a further embodiment, the carousel can further comprise a bag sealing system to close and/or seal bags when they are full. This can make transporting the bags more convenient for customers (i.e., items will be less likely to fall out of the bag on the way home) and provide enhanced security for both customers and retailers. This also can secure bags or other receptacles for shipping or other transport in order fulfillment or delivery environments. In some embodiments, the system can provide or direct application of labels, such as for shipping or delivery, to packed receptacles. Other features that enhance and improve bagging and item transport also can be included on the shopping bag carousel in various embodiments.

In various embodiments, the systems disclosed herein and/or their components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but also to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In embodiments, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. An item packaging carousel comprising:
a first tier and a second tier, each of the first tier and the second tier comprising a plurality of item receptacle compartments, each item receptacle compartment configured to hold at least one item receptacle;
a motor configured to rotate at least one of the first tier or the second tier to bring one of the plurality of item receptacles to an active filling position; and
an item packaging carousel control system comprising a processor and communications circuitry, the communications circuitry configured to receive item information from an item scanning system, and the item packaging carousel control system configured to provide a rotation signal to the motor to cause at least one of the first tier or the second tier to rotate to bring a selected one of the plurality of item receptacle compartments to an active filling position based on the received item information.

2. The item packaging carousel of claim 1, wherein the active bagging position is aligned with a conveyor system of the item scanning system.

3. The item packaging carousel of claim 1, wherein the motor is configured to rotate the first tier and the second tier independently.

4. The item packaging carousel of claim 1, wherein at least one of the plurality of item receptacle compartments comprises a bag readiness system.

5. The item packaging carousel of claim 4, wherein the bag readiness system comprises a bag opening component.

6. The item packaging carousel of claim 1, wherein the item information relates to an item scanned by the item scanning system.

7. The item packaging carousel of claim 6, wherein the item scanning system comprises a retail point-of-sale (POS) system.

8. The item packaging carousel of claim 1, wherein the item information comprises at least one of an item type, an item department, an item category, an item receptacle type, an item weight, an item dimension, or an item state.

9. The item packaging carousel of claim 8, wherein the item receptacle type comprises a receptacle material.

10. The item packaging carousel of claim 9, wherein the receptacle material comprises paper, plastic or cloth.

11. The item packaging carousel of claim 1, wherein the communications circuitry comprises wireless communications circuitry.

12. The item packaging carousel of claim 1, wherein the processor is configured to monitor a fill level of item receptacles on the item packaging carousel, and wherein the item packaging carousel control system is configured to provide a rotation signal to the motor to cause at least one of the first tier or the second tier to rotate to bring a selected one of the plurality of item receptacle compartments to an active filling position based on the fill level.

13. The item packaging carousel of claim 12, wherein the selected one of the plurality of item receptacle compartments brought to the active filling position based on the fill level is an item receptacle that is partially full and has not reached a maximum fill level.

14. The item packaging carousel of claim 12, wherein the selected one of the plurality of item receptacle compartments brought to the active filling position based on the fill level is an empty item receptacle, and wherein the fill level relates to an item receptacle previously in the active filling position and that reached a maximum fill level.

15. The item packaging carousel of claim 1, wherein the first tier is configured to hold a first type of item receptacle and the second tier is configured to hold a second type of item receptacle different from the first type of item receptacle.

16. The item packaging carousel of claim 15, wherein the carousel includes a third tier comprising a plurality of item receptacle compartments, each item receptacle compartment configured to hold at least one item receptacle.

17. A method of managing an item packaging carousel comprising:
providing an item packaging carousel, the item packaging carousel comprising a first tier and a second tier, each of the first tier and the second tier comprising a plurality of item receptacle compartments, each item receptacle compartment configured to hold at least one item receptacle, the item packaging carousel further comprising a motor configured to rotate at least one of the first tier or the second tier to bring one of the plurality of item receptacle compartments to an active filling position; and
providing communications circuitry to communicatively couple the item packaging carousel with an item scanning system such that the motor causes at least one of the first tier or the second tier to rotate to bring a selected one of the plurality of item receptacle compartments to the active filling position based upon item information received from the item scanning system.

18. The method of claim 17, wherein the item information relates to an item scanned by the item scanning system.

19. The method of claim 17, wherein the item information comprises at least one of an item type, an item department, an item category, an item receptacle type, an item weight, an item dimension, or an item state.

20. The method of claim 19, wherein the item receptacle type comprises a receptacle material.

21. The method of claim 17, further comprising:
monitoring a fill level of item receptacles on the item packaging carousel; and
causing the motor to rotate at least one of the first tier or the second tier to bring a selected one of the plurality of item receptacle compartments to an active filling position based on the monitored fill level.

22. The method of claim 21, wherein the selected one of the plurality of item receptacle compartments brought to the active filling position based on the monitored fill level is an item receptacle that is partially full and has not reached a maximum fill level.

23. The method of claim 21, wherein the selected one of the plurality of item receptacle compartments brought to the active filling position based on the monitored fill level is an empty item receptacle, and wherein the fill level relates to an item receptacle previously in the active filling position and that reached a maximum fill level.

24. The method of claim 17, wherein the item packaging carousel includes a third tier comprising a plurality of item receptacle compartments, each item receptacle compartment configured to hold at least one item receptacle.

25. A method of operating an item packaging carousel having a motor, a control system, and a rotating structure with a rotatable first tier and a rotatable second tier each having a plurality of item receptacle compartments, comprising:
receiving item information from an item scanning system related to an item scanned during a purchase transaction;
communicating the item information to the control system of the item packaging carousel;
monitoring compartment status information by the control system for each of the plurality of item receptacle compartments on the rotatable first tier and the rotatable second tier;
determining a selected compartment of the plurality of item receptacle compartments in which to package the item based on the item information and compartment status information;
rotating one of the rotatable first tier and the rotatable second tier with the motor to align the selected compartment with an active filling location; and
updating compartment status information upon placement of the item in the selected compartment at the active filling location.

26. The method of claim 25, wherein updating component status information includes sensing information regarding a weight or a capacity of an item receptacle being loaded in the selected compartment.

27. The method of claim 25, wherein updating component status information includes sensing information regarding a quantity of items loaded in the selected compartment.

28. The method of claim 25, further including displaying an indication for visual identification of the selected compartment upon determining the selected compartment.
